(19) United States
(12) Patent Application Publication
(10) Pub. No.: US 2006/0084710 A1
(43) Pub. Date: Apr. 20, 2006

(54) Flexible foams with low bulk densities and compressive strengths

(76) Inventors: Sven Meyer-Ahrens, Leverkusen (DE); Klaus Steinborn, Leverkusen (DE); Manfred Naujoks, Odenthal (DE)

Correspondence Address: BAYER MATERIAL SCIENCE LLC, 100 BAYER ROAD, PITTSBURGH, PA, 15205, US

(21) Appl. No.: 11/252,149

(22) Filed: Oct. 17, 2005

(30) Foreign Application Priority Data
Oct. 19, 2004 (DE) 1020040510482

(51) Int. Cl. C08G 18/48

(52) U.S. Cl. 521/131

(57) ABSTRACT

The present invention provides flexible polyurethane foams with bulk densities less than about 15 kg/m³ and compressive strengths less than about 1.5 kPa and a process for producing these foams. The inventive foams are produced where polyisocyanates are reacted with special polyol mixtures in combination with high amounts of water and carbon dioxide dissolved under elevated pressure as the blowing agent.

### FIELD OF THE INVENTION

The present invention relates to flexible polyurethane foams with bulk densities less than about 15 kg/m³ and compressive strengths less than about 1.5 kPa and a process for the production thereof.

### BACKGROUND OF THE INVENTION

Flexible polyurethane foams with densities of 15 kg/m³ and below and a compressive strength less 1.5 kPa were once produced using blowing agent combinations which contained water and CFCs. After the ban on CFCs, low bulk densities were obtainable only by using blowing agents such as dichloromethane or acetone or by foaming under reduced pressure. All these processes are associated with disadvantages, sometimes quite serious ones: in many countries dichloromethane is subject to stringent conditions with regard to the maximum workplace concentration and the emission values from industrial production plants, when using acetone the production plants have to be designed to be explosion-proof and the use of reduced pressure requires the costly encapsulation of production plant and permits continuous production to only a limited extent.

The use of water as the sole blowing agent and the corresponding increase in the amount of water used leads to foams with very poor mechanical properties. In addition, discoloration or even self-ignition of the foam can occur due to the exothermic nature of the blowing reaction. Depending on the polyol used, the hardness and brittleness of the foam produced may also be increased by the addition of larger amounts of water.

For the production of flexible foams with bulk densities of less than 21 kg/m³, U.S. Pat. No. 4,970,243 A suggests using water as blowing agent in amounts of 5 to 15 parts per 100 parts of polyol and working at very low NCO indices (the ratio of isocyanate groups to groups which can react with isocyanate in the reaction mixture multiplied by 100) of less than 80, preferably 40 to 65.

EP 0 719 627 B1 and EP 0 767 728 B2 disclose the use of carbon dioxide dissolved under pressure as a blowing agent for the production of conventional foams. EP 0 767 728 B2 points out that foams with bulk densities of 15 kg/m³ and below can be obtained by the use of water as an additional blowing agent. When using conventional polyol components, the use of 6 parts of CO₂ and 4.6 parts of water per 100 parts of polyol, bulk densities of 14 kg/m³ are produced. However, the resulting foams do not have the desired compressive strengths of well under 1.5 kPa.

U.S. Pat. No. 4,143,004 A and FR 2 172 860 A disclose special polyol mixtures for producing polyurethane flexible foams with particularly low hardness, so-called “hypersoft” foams. These polyol mixtures contain two polyetherpolyols which are immiscible with each other and have an overall ethylene oxide unit content of 50 to 70 wt. %. FR 2 172 860 A discloses that the polyol mixtures should have a primary hydroxyl group content of 35 to 55%, U.S. Pat. No. 4,143,004 A requires a primary hydroxyl group content of 55 to 80%. The foams produced have bulk densities in the range 20 to 30 kg/m³.

### SUMMARY OF THE INVENTION

The present invention provides foams with bulk densities less than 15kg/m³, preferably less than about 13 kg/m³ (in accordance with EN-ISO 845) and compressive strengths less than about 1.5 kPa, preferably less than about 1.0 kPa (in accordance with EN-ISO 3386-1) and otherwise good mechanical properties.

It has been found that these kinds of foams can be obtained when polyisocyanates are reacted with special polyol mixtures in combination with high amounts of water and carbon dioxide dissolved under elevated pressure as the blowing agent.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, OH values, functionalities and so forth in the specification are to be understood as being modified in all instances by the term “about.”

The present invention provides flexible foams with a bulk density less than 15 kg/m³, preferably less than 13 kg/m³ and a compressive strength less than 1.5 kPa, preferably less than 1,0 kPa, obtainable by the reaction of
a) aromatic polyisocyanate with
b) a polyol mixture comprising
b1) 60 to 90 parts by weight of at least one polyetherpolyol with a nominal functionality of 2 to 6, preferably 3, an oxyethylene content of >60 wt. %, preferably >70 wt. %, mainly primary OH groups, preferably 75 to 85% primary OH groups and an OH value (OHV) of 10 to 112, preferably 40 to 50; and
b2) 10 to 40 parts by weight of at least one polyetherpolyol with a nominal functionality of 2 to 6, preferably 3, an oxyethylene content of 0 to 30 wt. %, preferably 10 to 20 wt. %, mainly secondary OH groups, preferably 30 to 45% primary OH groups, and an OHV of 8 to 112;
c) water, preferably in amounts of at least 6 parts by weight per 100 parts by weight of b);
d) carbon dioxide dissolved under pressure in an amount of at least 6 parts by weight per 100 parts by weight of b);
e) optionally cross-linking agents;
f) with the use of foam stabilizers based on silicone, activators, metal catalysts and other auxiliary agents conventionally used in the production of PU foams;
   at a NCO index of 80 to 100, preferably 85 to 95.

Flexible foams according to the invention are produced by the reaction of aromatic polyisocyanates. Toluene diisocyanate (TDI) is preferably used for this purpose, in particular in the form of an isomer mixture which contains 80 wt. % 2,4-TDI (‘TDI 80’). In another embodiment, diphenylmethane diisocyanate (MDI), in the form of monomeric MDI, mixtures of MDI and its higher homologues (polymeric MDI) or mixtures of same is used as the polyisocyanate.

In a one embodiment of the present invention, component b2) contains a polyetherpolyol with an OHV of 28 to 35; in another embodiment, the OHV is 42 to 56. In another embodiment of the invention, component b2) contains a polymer polyol, a PHD polyol or a PIPA polyol. Polymer polyols are polyols which contain a proportion of solid polymers produced by radical polymerization of suitable monomers such as styrene or acrylonitrile in a base polyol. PHD polyols are prepared by the polyaddition reaction of diisocyanates with diamines, e.g. TDI and hydrazine, in a base polyol; PIPA polyols are prepared by the polyaddition reaction of diisocyanates with aminoalcohols. PIPA polyols are described in detail in GB 2072204 A, DE 31 03 757 A1 and U.S. Pat. No.4374209 A.

Optionally, cross-linking agents e) may also be used. Cross-linking agents are compounds with a molecular weight of 32 to 400 and contain at least two groups which can react with isocyanate. In a preferred embodiment of the invention, sorbitol, in an amount of 0.5 to 5 parts by wt., preferably 1 to 2 parts by wt., with respect to 100 parts by wt. of b), is used as a cross-linking agent.

Foams according to the invention are produced in a manner known in principle to a person skilled in the art, in a batchwise or continuous process, e.g. the Draka-Petzetakis, Maxfoam, Hennecke-Planiblock or Vertifoam process. Details can be found in G. Oertel (Ed.): “Kunststoff Handbuch”, vol. 7 “Polyurethane”, 3rd ed., Hanser Verlag, Munich 1993, pp. 193-220.

### EXAMPLES

The present invention is further illustrated, but is not to be limited, by the following examples. All quantities given in “parts” and “percents” are understood to be by weight, unless otherwise indicated.

Flexible foams were produced in accordance with the formulations given below in Table 1, using the following raw materials:
Polyol A: Glycerine started EO/PO polyether with about 72% EO, with mainly prim. OH groups and an OH value of 37;
Polyol B: Glycerine started EO/PO polyether with about 8% EO, with mainly sec. OH groups and an OH value of 48;
Isocyanate: TDI 80, (DESMODUR T 80, Bayer AG);
Stabilizer: Polyether-modified polysiloxane (TEGOSTAB BF 2370, Degussa-Goldschmidt AG);
Catalyst A: Solution of triethylenediamine in propylene glycol (DABCO 33LV, Air Products);
Catalyst B: Solution of bis-dimethylaminoethyl ether in propylene glycol (NIAX A1, GE (formerly WITCO/OSI)); and
Catalyst C: Tin dioctoate (DABCO T-9, Air Products).

All the foams were produced in a continuous process on a HENNECKE UBT 78 machine. The total polyol output rate was about 28 kg/min, the stirrer speed was 3500-4500 rpm. The polyol temperature was 25° C., the isocyanate temperature was 21° C. The polyol was metered in at about 30 bar, the isocyanate was metered in at about 85 bar (die pressure). Carbon dioxide was metered in via a NOVAFLEX unit made by HENNECKE.

Samples were taken from the blocks of foam, after being stored for 24 hours, to determine the mechanical characteristics: bulk density was determined according to EN-ISO 845; tensile strength and elongation at break were determined according to EN-ISO 1798; compressive strength 40% according to EN-ISO 3386-1; and compression set (90%) according to EN-ISO 1856.

TABLE 1

| | Example No. | | |
|---|---|---|---|
| | 1 | 2* | 3* |
| Polyol A (parts) | 75 | — | — |
| Polyol B (parts) | 25 | 100 | 100 |
| Carbon dioxide (CO₂) (parts) | 6 | 6 | 6 |
| Water (parts) | 6.00 | 6.00 | 4.6 |
| Stabilizer (parts) | 1.50 | 1.80 | 1.50 |
| Catalyst A (parts) | 0.10 | 0.10 | — |
| Catalyst B (parts) | 0.03 | 0.05 | 0.05 |
| Catalyst C (parts) | 0.05 | 0.25 | 0.17 |
| Isocyanate (parts) | 57.9 | 58.9 | 56.6 |
| index | 90 | 90 | 110 |
| Bulk density [kg/m³] | 11.3 | 13.5 | 13.6 |
| Tensile strength [kPa] | 92 | n.d. | 60 |
| Elongation at break [%] | 432 | n.d. | 157 |
| Compressive strength 40% | 0.44 | n.d. | 1.97 |
| [kPa] | | | |
| Compression set (90%) [%] | 15.8 | n.d. | 5.4 |
| Foam structure | fine, | sponge- | fine, |
| | irregular | like | regular |
| | | structure | |

*Comparison example

As can be appreciated by reference to Table 1, Example 1 provided a foam according to the invention which had the desired low compressive strength and low bulk density. The pore structure was perfect.

Example 2 describes the composition and test results for the production of a foam not according to the invention with a low bulk density. The CO₂ was not retained in the foam mixture and led to a sponge-like structure with large voids. It was not possible to determine the mechanical properties because homogeneous samples could not be obtained. Despite the greatly increased amount of water, the bulk density was higher than that of the foam according to the invention.

Example 3 also describes a foam not according to the invention. Although this was produced with large amounts of CO₂, the low bulk density and compressive strength of the foam according to the invention were not achieved.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A flexible foam comprising the reaction product at a NCO index of about 80 to about 100 of:
a) an aromatic polyisocyanate with
b) a polyol mixture comprising
b1) about 60 to about 90 parts by weight of at least one polyetherpolyol with a nominal functionality of about 2 to about 6, an oxyethylene content of greater than about 60 wt. % primary hydroxyl (OH) groups and with a hydroxyl value (OHV) of about 10 to about 112, and
b2) about 10 to about 40 parts by weight of at least one polyetherpolyol with a nominal functionality of about 2 to about 6, an oxyethylene content of 0 to about 30 wt. % secondary OH groups and an OHV of about 8 to about 112;
c) water; and
d) carbon dioxide dissolved under pressure in an amount of at least about 6 parts by weight per 100 parts by weight of b);
e) optionally cross-linking agents;
f) and optionally at least one of foam stabilizers based on silicone, activators, metal catalysts and other auxiliary agents;
wherein the flexible foam has a bulk density less than about 15 kg/m³ and a compressive strength less than about 1.5 kPa.

2. The flexible foam according to claim 1, wherein the aromatic polyisocyanate is chosen from diphenylmethane diisocyanate, polymeric MDI or mixtures thereof.

3. The flexible foam according to claim 1, wherein component b2) contains a polymer polyol.

4. The flexible foam according to claim 1, wherein component b2) contains a PHD polyol.

5. The flexible foam according to claim 1, wherein component b2) contains a PIPA polyol.

6. The flexible foam according to claim 1, wherein the cross-linking agent e) is sorbitol.

7. The flexible foam according to claim 1, wherein the foam has a bulk density less than about 13 kg/m³.

8. The flexible foam according to claim 1, wherein the foam has a compressive strength less than about 1.0 kPa.

9. A process for producing flexible foams comprising reacting at a NCO index of about 80 to about 100:
a) an aromatic polyisocyanate;
b) a polyol mixture comprising,
b1) about 60 to about 90 parts by weight of at least one polyetherpolyol with a nominal functionality of about 2 to about 6, an oxyethylene content of greater than about 60 wt. % primary hydroxyl (OH) groups and with a hydroxyl value (OHV) of about 10 to about 112, and
b2) about 10 to about 40 parts by weight of at least one polyetherpolyol with a nominal functionality of about 2 to about 6, an oxyethylene content of 0 to about 30 wt. % secondary OH groups and an OHV of about 8 to about 112;
c) water in an amount of at least about 6 parts by weight per 100 parts by weight of b); and
d) carbon dioxide dissolved under pressure in an amount of at least about 6 parts by weight per 100 parts by weight of b);
e) optionally cross-linking agents;
f) optionally one or more of foam stabilizers based on silicone, activators, metal catalysts and other auxiliary agents,
wherein the flexible foam has a bulk density less than about 15 kg/m³ and a compressive strength less than about 1.5 kPa.

10. The process according to claim 9, wherein the aromatic polyisocyanate is chosen from diphenylmethane diisocyanate, polymeric MDI or mixtures thereof.

11. The process according to claim 9, wherein component b2) contains a polymer polyol.

12. The process according to claim 9, wherein component b2) contains a PHD polyol.

13. The process according to claim 9, wherein component b2) contains a PIPA polyol.

14. The process according to claim 9, wherein the cross-linking agent e) is sorbitol.

15. The process according to claim 9, wherein the flexible foam has a bulk density less than about 13 kg/m³.

16. The process according to claim 9, wherein the flexible foam has a compressive strength less than about 1.0 kPa.

17. The flexible foam made by the process according to claim 9.
